(19) United States
(12) Patent Application Publication
(10) Pub. No.: US 2008/0089510 A1
(43) Pub. Date: Apr. 17, 2008

(54) Personal plug and remote phone (PPRP)

(76) Inventor: Alvin Julius Watson SR., Nashville, TN (US)

Correspondence Address: Alvin Julius Watson, Sr., 3004 Kings Lane, Nashville, TN, 37218, US

(21) Appl. No.: 11/810,812

(22) Filed: Oct. 10, 2007

Related U.S. Application Data
(60) Provisional application No. 60/812,741, filed on Jun. 11, 2006.

(51) Int. Cl. H04M 1/00

(52) U.S. Cl. 379/387.01

(57) ABSTRACT

The personal plug and telephone facility with its associated apparatus provides an improved device for public, private, and business telephone communications. This new functionality would permit a caller to use his standard plug-in cell or his remote cell phone to make a landline call. Adapters would be used to make the conversions, one adapter for pay phones, and a smaller adapter for home and office telephone systems.

The following overview will summarize the distinctive features of the product, product modification needs and guidelines, and the functions and services upon which the system will operate. The concept of the “PERSONAL PLUG and REMOTE PHONE” (PPRP) and its associated apparatus is based on a design concept which I have created that would provide additional function to a public, personal, or business phone. This new functionality would permit the caller to use his hand-held phone, and make landline public, private, or business calls simply by pushing the remote button on the phone. The PPRP system would include three types of apparatus: a public/home/business phone apparatus and two types of PPRP phones—standard and remote. The PPRP system would also include adapters for conversion of the conventional communication schemes.

The PPRP would be designed as a standard or remote regular phone with modification. The PPRP ADAPTER would allow the PPRP to serve the same purpose as the public phone apparatus. This would allow the user the convenience of making phone calls from any public phone terminal location, when desired or needed, without paying the expensive cell phone minutes of frequent repetitive calling, or of having to handle unsanitary receivers and mouthpieces of public phone systems.

Likewise, the PPRP ADAPTER could be plugged into a home or business phone, thereby providing a connection to it, as well, with a standard or remote PPRP.

The PPRP PUBLIC PHONE would consist of six jacks built into the face of the phone, and one or more internal multi-channel transceivers (transmitter/receiver) which would operate in a manner similar to a transceiver-type of phone built into cordless home phones (900 MHz, 1.8 GHz, etc.) with the power options required for the specific location. There would be multiple line connections for each PPRP PUBLIC PHONE. The standard PPRP would include a built-in retractable cord with a plug affixed to the end. The plug on the end of this cord would fit into any one of the jacks on the front of the PPRP PUBLIC PHONE. Six people with a standard PPRP could therefore, simultaneously, use one PPRP PUBLIC PHONE board of plugs in an umbilical fashion and six people could simultaneously use the remote access allowing twelve people the use of one public phone.

Each remote PPRP would include a built-in, short-range, radio frequency (RF) transceiver of one of the types built into handsets of cordless receivers. Via this built-in transceiver, each remote PPRP would make an RF connection to a nearby PPRP PUBLIC PHONE by pressing the REMOTE button on the phone. A PPRP PUBLIC PHONE would be able to process numerous cordless calls simultaneously along with the corded ones; a convenient feature for, especially, airport locations. The remote PPRP purchased by the user would generally be compatible with his or her home cordless phones. If the user were at home with his remote PPRP and heard a phone ringing in another room, he or she would answer it by simply pressing the remote transfer button on the remote PPRP and speaking into the phone. In this way, a single phone would be used in, outside, and away from the home.

This new technology could be incorporated into regular cell phones just with the insertion of a transfer chip. In certain areas where landlines are not accessible or even convenient to utilize, the user could press the cell button and communicate on the cell phone component of the PPRP system. Thus, the PPRP would have both landline and cell phone capability.

The PPRP PUBLIC PHONE would be the same size as the current standard pay phone. The two kinds of PPRP CELL PHONES (standard and remote ) would be the same size as current cell phones.

Function and Features

PPRP would provide a type of PUBLIC PHONE accessibility with connection to a modified version of cell phone—avoiding the unsanitary conditions of ordinary pay phones and the expense of repetitive cell phone communication. The over-all appealing features of PPRP aside form the sanitary aspects, are the reduced cost, avoidance of fade-out, ease of use, and convenience. With the advent of the cell phone, the pay phone has fallen into declining use. However, cell phone minutes are quite expensive when frequent calling is the norm. The PPRP system would allow a user to make inexpensive landline phone calls from a public phone. Potentially unsanitary aspects of public phone use would be eliminated by the PPRP. The central elements of the PPRP system would be modified public phones and cell phones designed to connect to and interact with each other. There would be two kinds of PPRP systems—standard and remote. The standard PPRP would include a built-in cord mounted on a spring-loaded retractor mechanism. This cord would terminate in a plug to be inserted into one of the six jacks built into the front of a PPRP PUBLIC PHONE.

Once connected in this way, the standard PPRP and PPRP PUBLIC PHONE would combine to function like an ordinary pay phone. However, instead of handling the receiver of a public pay phone, the user would be handling his or her own personal cell phone. The call would travel through the wired system of the landline phone network and not utilize the towers and stations of a cell phone network. As a result, it would be as inexpensive as an ordinary pay phone call. In addition, the call would not have any “fade-out” or other cell phone types of inconveniences. One of the most aggravating things about making a call from a pay phone is the need to acquire the right amount of change beforehand. This is especially annoying because a person rarely knows in advance how much money will be needed to complete a call. With a PPRP call, the user's cell phone would be identified automatically by the pay phone network and the charge added to the user's cell phone bill. Like minutes, individual phone call units could be purchased and a window or portion of the screen would indicate the number of phone call minutes that could be placed. There would, therefore, be no need to acquire coins before making a PPRP PUBLIC PHONE call.

Because public phones would no longer accumulate coins, they would no longer be a target of vandals. This would reduce the cost of equipment and maintenance fees for public phone companies, reduce the price of public phone calls (since companies must pass on costs resulting from vandalism to customers), and reduce the likelihood of a malfunctioning phone being encountered.

Another annoying feature of ordinary public phones has to do with the length of the cord connected to the receivers. These short cords make use of the phone uncomfortable. With the PPRP system, the cord would be built into the user's cell phone (incorporated into the retractable mechanism). As a result, cords would be longer and more comfortable to use.

Because there would be six jacks built onto the front of the PPRP PUBLIC PHONE, six people with standard PPRP systems could use a single public phone at a time. The need to wait for a public phone would be eliminated. To cut down the expense of the conversion to PPRP and retain double compatibility of public phones, the public phone company could add a PPRP ADAPTER to the bottom of a conventional public phone. Or, the phone company would have the option of changing the face plate of existing public phones and adjusting the system to accommodate the PPRP.

In addition to these public phone related conveniences, the remote PPRP owner would be able to use that cell phone as a cordless headset inside the home. This would Allow the user to answer phone calls from any location in the house as long as the remote PPRP was on his/her person.

Manufacturing Processes

Circuit boards would have to be designed and fabricated for this product. The circuit boards required, their design and fabrication would use conventional processes.

The cases for the PPRP's could be produced from a plastic such as durable polycarbonate. This material, which is readily available in a variety of colors, is reasonably priced and easily formed by a wide range of plastic processors. Injection molding might be a standard approach to the production.

The cases of the public phone and public phone adapter would be formed from steel and plastic using conventional machinery processes, connections, and techniques.

Marketing Strategy

It is the intention of the designer/inventor of this concept, Alvin J. Watson, Sr. to sell or assign this invention to telecommunications companies and other types of communication outlets in the related industries. It is understood that the companies involved would have to obtain approval from the Federal Communications Commission (FCC) and associated agencies regarding all technical and regulatory concerns.

### BRIEF DESCRIPTION OF THE DRAWINGS

FIG. 1 sets forth a perspective view of a plug-in and remote phone access telephone facility constructed in accordance with the present invention.

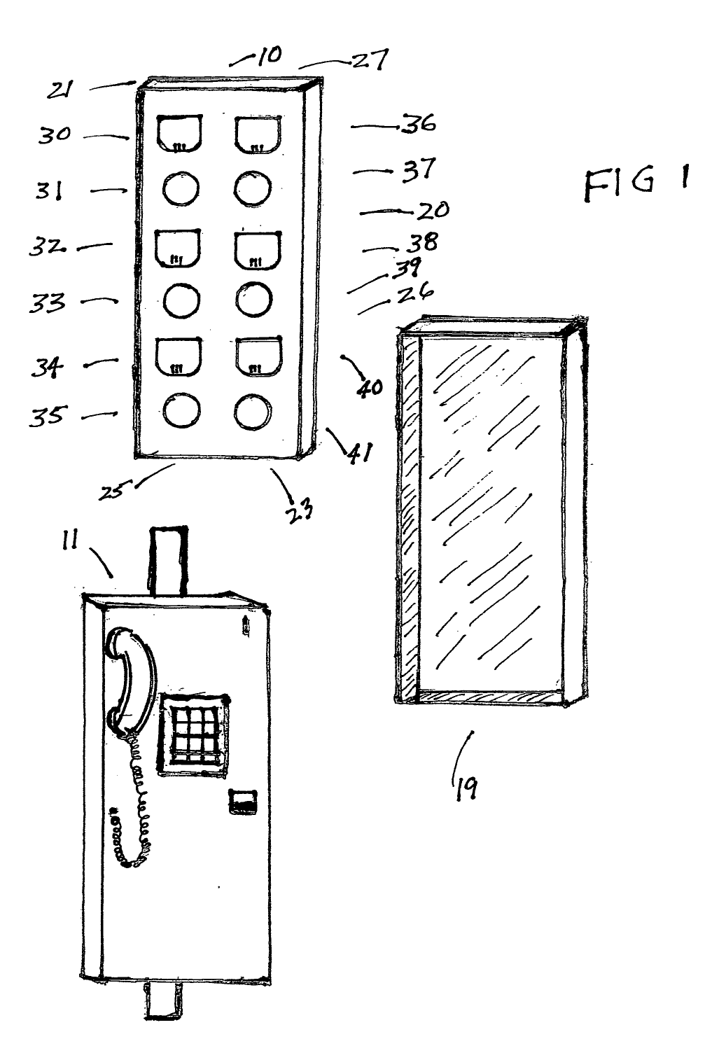

FIG. 1A sets forth a perspective view of an adapter, using a plug-in and remote telephone apparatus for home or office use.

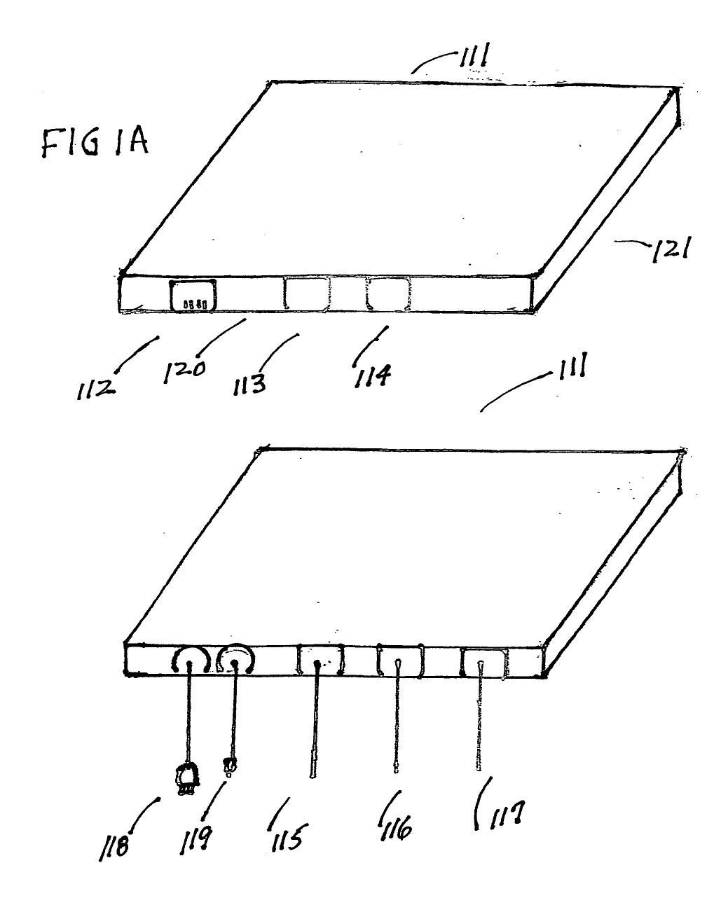

FIG. 2 sets forth a perspective view of a standard plug-in cell phone with a retractable spring cord and plug, which can be used in an alternative plug-in and remote access telephone facility.

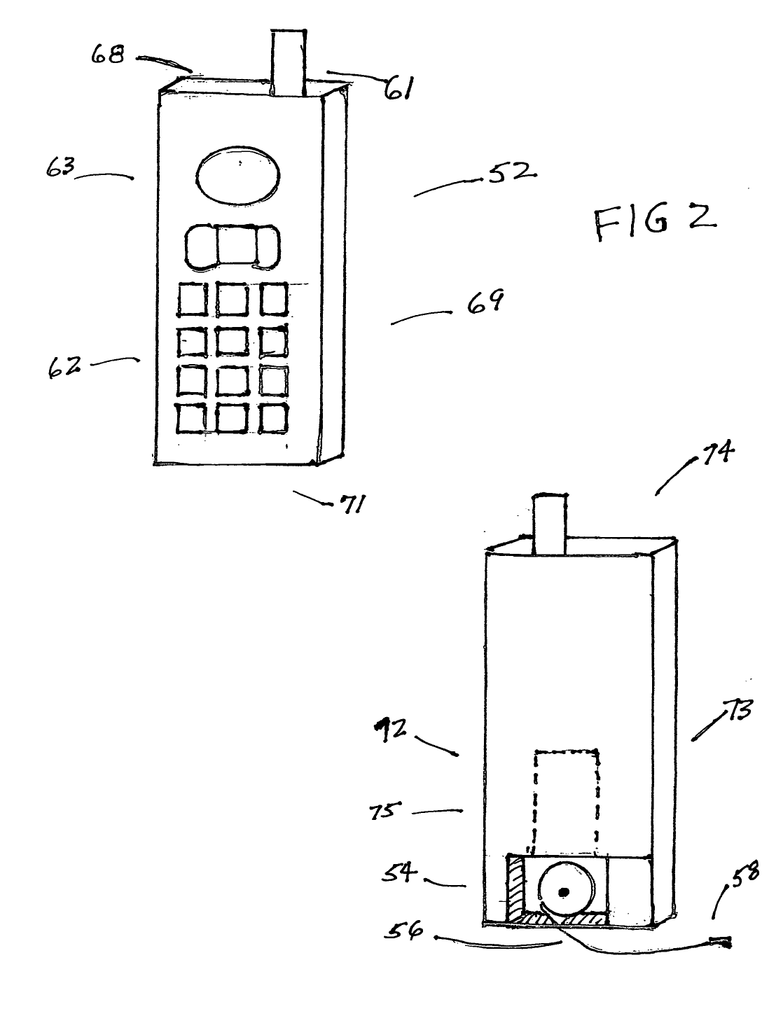

FIG. 3 sets forth a perspective view of a remote modified cell phone which can be used for an alternative plug-in and remote access telephone facility.

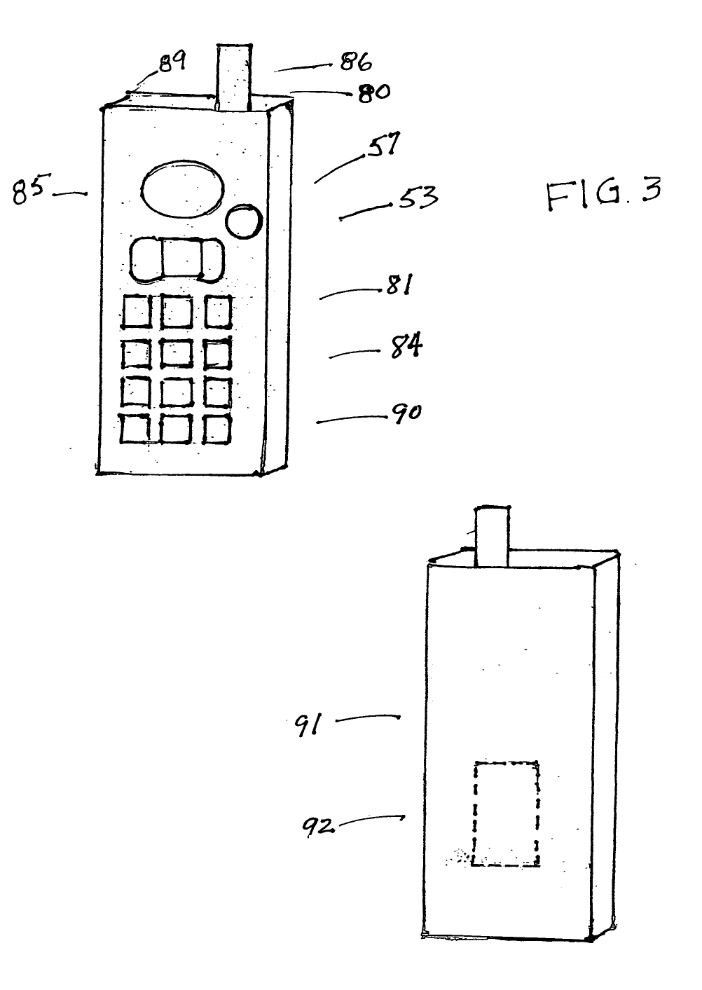

1. A personal plug and remote telephone facility co-operating with a public telephone line for improved public communication comprising:
A housing defining an interior cavity providing a coin-free connection to a public phone line.
A plurality of plug-in and remote telephone receptacles contained in an adapter connecting to existing converted pay phones.

2. A smaller version of a plug-in and remote telephone adapter as set forth in claim 1 for home and office use, connecting a standard or remote cell phone call to a home or office telephone line.

3. A standard personal plug cell phone as set forth in claim 1 and claim 2 comprising;
a retractable spring cord with an end plug to access any one of the available plug-in telephone receptacles on the personal plug and remote phone facility.

4. A remote cell phone as set forth in claim 1 and claim 2 comprising;
a remote access button to connect a cell phone call to any one of the available remote telephone receptacles on the personal plug and remote telephone facility.
